(19) United States
(12) Patent Application Publication
(10) Pub. No.: US 2020/0014266 A1
(43) Pub. Date: Jan. 9, 2020

(54) ELECTRIC MOTOR HAVING ELECTRIC CONDUCTORS SPACED APART FROM STATOR SLOTS

(71) Applicant: Dr. Ing. h.c. F. Porsche Aktiengesellschaft, Stuttgart (DE)

(72) Inventors: Stefan Oechslen, Stuttgart (DE); Johannes Stoll, Schorndorf (DE); Philipp Berendes, Stuttgart (DE); Jörg Schneider, Stuttgart (DE); Wolfgang Merath, Argenbühl (DE); Daniel Bodenmiller, Argenbühl-Eisenharz (DE); Wolfgang Thaler, Leutkirch (DE)

(73) Assignee: Dr. Ing. h.c. F. Porsche Aktiengesellschaft, Stuttgart (DE)

(21) Appl. No.: 16/458,731

(22) Filed: Jul. 1, 2019

(30) Foreign Application Priority Data
Jul. 3, 2018 (DE) 102018116031.3

(51) Int. Cl. H02K 3/24; H02K 1/04; H02K 1/16; H02K 9/197

(52) U.S. Cl. CPC H02K 3/24; H02K 9/197; H02K 1/16; H02K 1/04

(57) ABSTRACT

An electric motor includes a stator having a stator lamination stack and electric conductors. The stator lamination stack has a plurality of stator laminations, wherein the stator lamination stack has axial slots. The stator lamination stack has a plurality of positioning disks, and the positioning disks have leadthroughs. The electric conductors are arranged in the slots, being passed through the leadthroughs, wherein the leadthroughs have positioning regions for positioning the electric conductors. Also described is a method for operating an electric motor and a method for producing an electric motor.

### CROSS-REFERENCE TO RELATED APPLICATION

This application claims priority to German Patent application No. DE 10 2018 116 031.3, filed Jul. 3, 2018, which is incorporated by reference herein in its entirety.

### FIELD OF THE INVENTION

The present invention relates to an electric motor, in particular to a permanently excited synchronous machine as an internal rotor motor, preferably for use in motor vehicles. The present invention furthermore relates to a method for operating an electric motor and to a method for producing an electric motor.

### BACKGROUND OF THE INVENTION

Electric motors in motor vehicles generally have a stator and a rotor. Here, the stator has a stator lamination stack, which essentially comprises adjacently arranged stator laminations of the same geometry. The stator lamination stack reduces eddy current losses due to electric conductors laid in slots of the stator lamination stack.

The electric conductors must be insulated relative to the stator lamination stack. According to the prior art, this is accomplished by producing an electrically insulating layer in the slots between the electric conductors and the stator lamination stack.

Particularly in the case of high-performance electric motors, waste heat must be dissipated from the electric conductors, the stator lamination stack and especially also from the end windings of the electric conductors. Dissipation of the waste heat is generally accomplished by cooling with a cooling liquid. There are various concepts for this purpose. One concept envisages directly cooling the end windings. Here, cooling of the parts of the electric conductors in the slots and cooling the stator lamination stack is accomplished by conducting the heat from these parts through the electric conductors to the end windings. Another concept envisages passing the coolant through the slots of the stator lamination stack and allowing the coolant to flow around all the parts to be cooled. However, there are significant disadvantages with this. According to the prior art, the electric conductors rest without external fixing in the slots. Owing to relative movements caused, for example, by the flowing coolant, they can damage each other or the insulating layer in the slots. Moreover, the flow geometry within the slots is undefined and stagnant areas arise in which the coolant does not flow but is stationary, the conductors are not always completely wetted and the pressure loss in pumping the coolant is increased. It is likewise not possible to guarantee uniform flow with high fill factors of the slots. Moreover, the insulating layer in the slots and insulating layers around the electric conductors not only form electric insulators but also thermally insulate the stator lamination stack and the electric conductors and thus reduce the cooling of said parts.

### SUMMARY OF THE INVENTION

Described herein is an electric motor which does not have the disadvantages of the prior art but offers a defined flow geometry within the slots and does not require electric insulation of the slots.

According to one aspect, an electric motor having a stator, wherein the stator has a stator lamination stack and electric conductors, wherein the stator lamination stack has a plurality of stator laminations, wherein the stator lamination stack has axial slots, wherein the stator lamination stack has a plurality of positioning disks, wherein the positioning disks have leadthroughs, wherein the electric conductors are arranged in the slots, being passed through the leadthroughs, and wherein the leadthroughs have positioning regions for positioning the electric conductors.

The electric motor according to aspects of the invention makes it possible to fix the electric conductors within the slots of the stator lamination stack by means of the positioning regions of the positioning disks. The electric conductors can therefore be positioned with a defined flow geometry within the slots.

The stator laminations are arranged parallel to one another. The positioning disks are shaped in a manner similar to the stator laminations but have leadthroughs at the points which form the slots in the stator laminations of the stator lamination stack. It is conceivable for the leadthroughs to have a geometry similar to the points which form the slots in the stator laminations of the stator lamination stack. According to aspects of the invention, however, the areas of the leadthroughs are smaller since the leadthroughs have positioning regions for positioning, i.e. fixing, the electric conductors.

It is conceivable for the positioning disks to have the same external geometry as the stator laminations. It is furthermore conceivable for the leadthroughs to be open toward the geometric center of the positioning disks in a radial direction. However, it is also conceivable for the leadthroughs to be closed toward the geometric center of the positioning disks in a radial direction.

Advantageous embodiments and developments of the invention can be found in the subclaims and in the description with reference to the drawings.

According to a preferred embodiment of the invention, it is envisaged that the electric conductors are spaced apart from the stator lamination stack by the leadthroughs. This makes it possible to dispense with an electrically insulating layer between the electric conductors and the stator lamination stack, reducing the manufacturing outlay and improving cooling. For this purpose, the area through which an electric conductor can be guided through a leadthrough is smaller than the cross-sectional area of a slot parallel to the main plane of extent of the positioning disk, with the result that edges of the leadthroughs project into the slots in the stator lamination stack in the region of the positioning disks. These projections space the electric conductors apart from the stator lamination stack.

According to another preferred embodiment of the invention, it is envisaged that the electric conductors are spaced apart from one another by the positioning regions. This makes it possible to dispense with an electrically insulating layer on the electric conductors. It is conceivable for each of the positioning regions to be provided to accommodate one electric conductor.

For this purpose, the positioning regions are preferably each shaped to at least partially surround one electric conductor in each case. This makes it possible for the shape of the positioning regions parallel to the main plane of extent of the positioning disk to correspond at least in parts to the cross section of the electric conductor orthogonally to the main direction of extent thereof. In this case, regions of the leadthrough which are not positioning regions are shaped in such a way that it is impossible for an electric conductor to be passed through them.

It is conceivable for different electric conductors, each having different cross sections orthogonally to the main direction of extent thereof, to be passed through the leadthroughs and, in the process, to be positioned by different positioning regions, each having different shapes matching the respective different cross sections of the electric conductors parallel to the main plane of extent of the positioning disk. It is conceivable, for example, for electric conductors having relatively large cross sections to be positioned by relatively large positioning regions and for electric conductors having relatively small cross sections to be positioned by relatively small positioning regions.

According to another preferred embodiment of the invention, it is envisaged that the positioning disks are manufactured from a ceramic material. Corresponding ceramic materials are robust, excellent insulators and heat resistant.

According to another preferred embodiment of the invention, it is envisaged that the positioning disks are manufactured from a plastic. Corresponding plastics are robust and excellent insulators. Moreover, plastics generally have a lower wear resistance than ceramic materials, leading in the long term to less wear on the electric conductors during the operation of the electric motor when plastics are used instead of ceramic materials in the production of the positioning disks.

According to another preferred embodiment of the invention, it is envisaged that the positioning disks are manufactured from sheet metal, wherein the positioning regions have insulating regions. It is conceivable for the insulating regions to be produced from a ceramic material. The insulating regions insulate the electric conductors from each other and from the stator lamination stack.

According to another preferred embodiment of the invention, it is envisaged that one positioning disk is arranged at each of the axial ends of the stator lamination stack. This enables the precisely positioned introduction of the electric conductors into the slots.

According to another preferred embodiment of the invention, it is envisaged that the positioning disks are arranged at regular intervals between the stator laminations. The positioning regions of the leadthroughs of the positioning disks thus offer points of support for the electric conductors at regular intervals in the slots. In this case, the spacing between the individual positioning disks is dependent, for example, on the stiffness of the electric conductors.

According to another preferred embodiment of the invention, it is envisaged that the electric motor has a cooling device for cooling a cooling liquid. This advantageously allows liquid cooling of the electric motor. For this purpose, it is conceivable for the electric motor to have a heat exchanger.

According to another preferred embodiment of the invention, it is envisaged that the electric motor has a cooling liquid circuit, wherein the slots are part of the cooling liquid circuit. This allows direct cooling of the electric conductors and of the stator lamination stack. For this purpose, it is conceivable for the electric motor to have at least one coolant pump. It is conceivable for the leadthroughs between the positioning regions, that is to say also between the electric conductors, to have free spaces in the axial direction in the slots to allow cooling liquid to flow through the stator.

According to another preferred embodiment of the invention, it is envisaged that the electric motor has a sleeve for sealing the stator with respect to a rotor space. This ensures that no coolant escapes from the stator, in particular that no coolant enters the rotor region, which would lead to significant frictional losses between the rotor and the stator.

The invention furthermore relates to a method for operating an electric motor, wherein electric current flows through electric conductors of a stator which are arranged in slots of a stator lamination stack, wherein the electric conductors are held in the respective position thereof by positioning regions of positioning disks, and wherein the electric conductors are spaced apart from the stator lamination stack and from one another by the positioning regions.

The method according to aspects of the invention allows effective cooling of the electric conductors and the stator lamination stack because it is possible to dispense with insulation of the slots and of the electric conductors. Moreover, the method according to aspects of the invention makes it possible for the electric conductors to be fixed mechanically and thus to ensure that no damage to said conductors or to the stator lamination stack is caused by movements of the electric conductors.

It is conceivable for the electric motor to be an electric motor.

According to another preferred embodiment of the invention, it is envisaged that a coolant is passed through the slots to cool the electric conductors and the stator lamination stack. This allows direct cooling of the electric conductors and of the stator lamination stack. For this purpose, it is conceivable for the coolant to be passed through free spaces provided by the spacing apart of the electric conductors.

For this purpose, it is conceivable for the coolant to be cooled by means of a heat exchanger. It is furthermore conceivable for the coolant to be pumped through the electric motor in a circuit by at least one pump.

The invention furthermore relates to a method for producing an electric motor, wherein, to produce the stator, stator laminations are joined together to form a stator lamination stack, wherein positioning disks are arranged between the stator laminations, wherein electric conductors are arranged in slots of the stator lamination stack by means of leadthroughs of the positioning disks, wherein the electric conductors are pushed into positioning regions of the positioning disks.

The method according to aspects of the invention makes it possible to dispense with expensive electric insulation of the slots and of the electric conductors and to produce a defined flow geometry in the slots of the stator lamination stack. The method according to aspects of the invention furthermore also makes it possible to dispense with slot base insulation but to provide the conductors with attenuated electric insulation in comparison with the prior art.

### BRIEF DESCRIPTION OF THE DRAWING

Further details, features and advantages of the invention will become apparent from the drawings and from the following description of preferred embodiments with reference to the drawings. Here, the drawings illustrate merely illustrative embodiments of the invention, which do not restrict the concept underlying the invention.

FIGS. 1a and 1b illustrate schematically the positioning disk according to one illustrative embodiment of the present invention.

FIGS. 2a and 2b illustrate schematically the positioning disk according to another illustrative embodiment of the present invention.

FIG. 3 illustrates schematically a segment of the positioning disk according to another illustrative embodiment of the present invention in the axial direction.

### DETAILED DESCRIPTION OF THE INVENTION

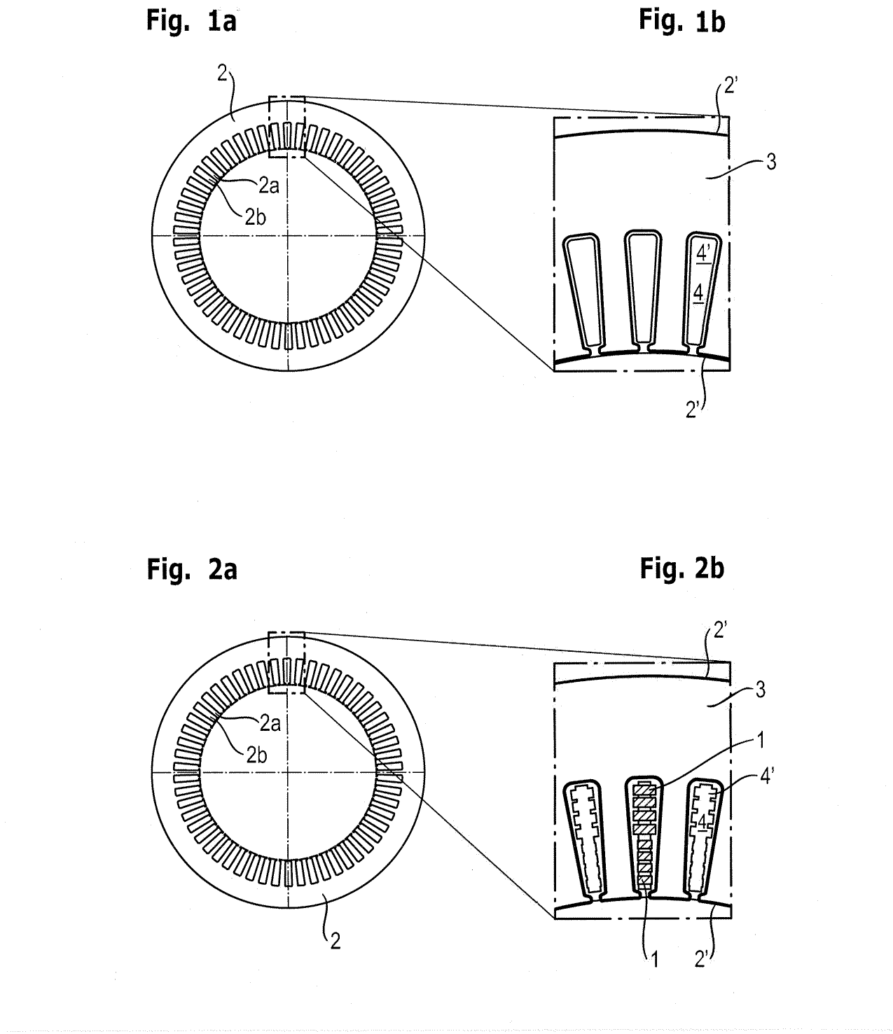

FIGS. 1a and 1b illustrate schematically the stator lamination 2 and the positioning disk 3 according to one illustrative embodiment of the present invention. FIG. 1a shows the stator lamination 2. When the stator laminations 2 are joined together to form a stator lamination stack, radial teeth 2a and radial interspaces 2b between the teeth 2a form the slots of the stator lamination stack.

FIG. 1b shows a segment of the positioning disk 3. The geometric shape of the positioning disk 3 corresponds very largely to the geometric shape of the stator lamination 2, illustrated here is an outline of the stator lamination 2′. The positioning disk 3 is produced from a plastic. The leadthroughs 4 of the positioning disk 3 are arranged in a manner centered relative to the interspaces 2b of the stator lamination 2. The extents of the leadthroughs 4 are less than the extents of the interspaces 2b, and therefore parts of the positioning disk 3 project into the slots of the stator lamination stack. The projections of the positioning disk 3 form the positioning region 4′, which spaces the electric conductors 1 (not shown) apart from the stator lamination stack. The leadthroughs 4 are closed toward the center of the positioning disk 3. However, it is also conceivable for the leadthroughs 4 to be open toward the center of the positioning disk 3.

FIGS. 2a and 2b illustrate schematically the stator lamination 2 and the positioning disk 3 according to another illustrative embodiment of the present invention. FIG. 2a shows the stator lamination 2. FIG. 1b once again shows a segment of the positioning disk 3. The geometric shape of the positioning disk 3 corresponds very largely to the geometric shape of the stator lamination 2, illustrated here as an outline of the stator lamination 2′. In the region of the leadthroughs 4, the positioning disk 3 is configured in such a way that the positioning regions 4′ are matched to the cross section of the electric conductors 1 (in this case shown only in the central leadthrough 4). On the one hand, this allows the spacing apart of the electric conductors 1 and, on the other hand, allows a defined flow geometry in the slots and the possibility of coolant flow between the electric conductors 1.

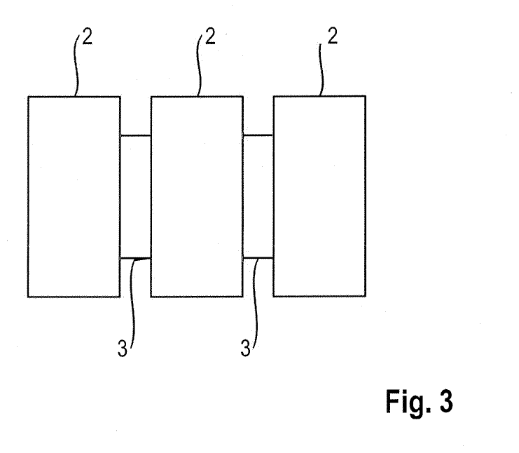

FIG. 3 illustrates schematically a segment of the positioning disk according to another illustrative embodiment of the present invention in the axial direction. The stator lamination stack 2 and the positioning disk 3 are shown in segments.

What is claimed is:

1. An electric motor comprising:
a stator having a stator lamination stack and electric conductors,
wherein the stator lamination stack has a plurality of stator laminations, axial slots, and a plurality of positioning disks having leadthroughs,
wherein the electric conductors are arranged in the slots and positioned through the leadthroughs, and
wherein the leadthroughs have positioning regions for accommodating the electric conductors.

2. The electric motor as claimed in claim 1, wherein the electric conductors are spaced apart from the stator lamination stack by the leadthroughs.

3. The electric motor as claimed in claim 1, wherein the electric conductors are spaced apart from one another by the positioning regions.

4. The electric motor as claimed in claim 1, wherein the positioning regions are each shaped to at least partially surround one electric conductor.

5. The electric motor as claimed in claim 1, wherein the positioning disks are composed of ceramic material.

6. The electric motor as claimed in claim 1, wherein the positioning disks are composed of plastic.

7. The electric motor as claimed in claim 1, wherein the positioning disks are composed of sheet metal, and wherein the positioning regions have insulating regions.

8. The electric motor as claimed in claim 1, wherein one positioning disk is arranged at each axial end of the stator lamination stack.

9. The electric motor as claimed in claim 1, wherein the positioning disks are arranged at regular intervals between the stator laminations.

10. The electric motor as claimed in claim 1, wherein the electric motor has a cooling device for cooling a cooling liquid.

11. The electric motor as claimed in claim 1, wherein the electric motor has a cooling liquid circuit, and the slots are part of the cooling liquid circuit.

12. The electric motor as claimed in claim 11, wherein the electric motor has a sleeve for sealing the stator with respect to a rotor space.

13. A method for operating an electric motor, said method comprising:
distributing electric current flow through electric conductors of a stator which are arranged in slots of a stator lamination stack, wherein the electric conductors are held in respective positions by positioning regions of positioning disks, and wherein the electric conductors are spaced apart from the stator lamination stack and from one another by the positioning regions.

14. The method as claimed in claim 13 further comprising passing a coolant through the slots to cool the electric conductors and the stator lamination stack.

15. A method for producing an electric motor, said method comprising:
producing the stator by joining together stator laminations to form a stator lamination stack,
arranging positioning disks between the stator laminations,
arranging electric conductors in slots of the stator lamination stack using leadthroughs of the positioning disks, and
pushing the electric conductors into positioning regions of the positioning disks.
